(19) United States
(12) Patent Application Publication
(10) Pub. No.: US 2006/0127861 A1
(43) Pub. Date: Jun. 15, 2006

(54) Laser apparatus for treating hard tissues and method for using the apparatus

(76) Inventors: Paolo Villoresi, Padova (IT); Stefano Bonora, Porto Mantovano (IT)

Correspondence Address: BAKER & DANIELS LLP;111 E. WAYNE STREET, SUITE 800, FORT WAYNE, IN, 46802, US

(21) Appl. No.: 10/533,521

(22) PCT Filed: Oct. 30, 2003
(86) PCT No.: PCT/EP03/12087

§ 371 Date: Nov. 1, 2005

(30) Foreign Application Priority Data
Nov. 4, 2002 (IT) MI2002A002332

(51) Int. Cl. A61C 1/00; A61C 5/00

(52) U.S. Cl. 433/215; 433/29

(57) ABSTRACT

A semiconductor laser apparatus combined with a chromophore and a method for using them in treating hard tissues, such as for example dental tissue, in which elements (3) for applying a chromophore in the area of the tissue to be treated are coupled to a semiconductor laser (4), elements for conveying (5, 6) the laser light and for focusing (7) the laser light on the tissue to be treated also being coupled to the laser; the chromophores can be chosen among different chromophorous agents and must have a high coefficient of absorption at the wavelength of the laser chosen for the type of treatment and/or tissue to be treated.

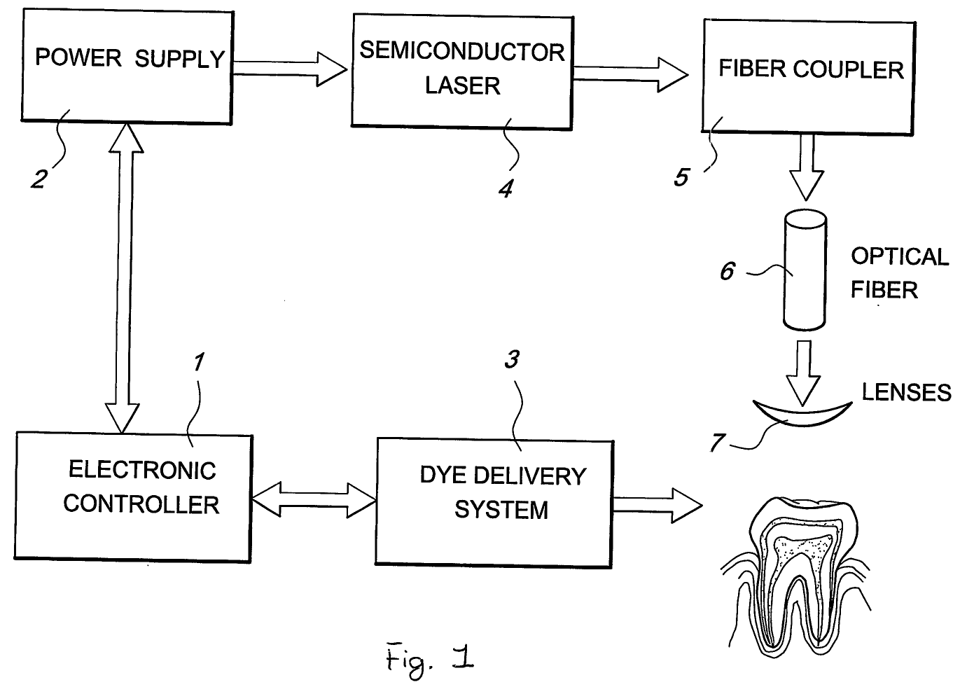

### TECHNICAL FIELD

The present invention relates to a semiconductor laser apparatus and to a method for using it to treat hard tissues.

### BACKGROUND ART

In dentistry it is often necessary to act on the “hard” tissues of the tooth, such as enamel and dentin, and on so-called “soft” tissues, such as for example gum tissue. In both cases, laser radiation has been applied widely during the last decade because it is an almost painless tool in treating hard tissues and has an excellent cutting and cauterization power for soft tissues.

The use of laser has been proposed, through the years, as an alternative to conventional mechanical methods, in order to reduce the use of anesthetics, which have several contraindications, and the pain that procedures of this kind can cause to the patient. Moreover, with adapted optical systems it is possible to focus the laser so as to couple its radiation in an optical fiber. This allows to carry the laser light to the treatment spot. Here, if appropriate, by means of a further optical system it is possible to refocus the laser beam on a very small area that is compatible with the dimensional ranges involved in this kind of procedure and therefore act with greater precision on the surface to be treated.

The techniques developed to apply a laser to hard and soft tissues of teeth are numerous, since in the two cases there are differences in the optical characteristics (coefficient of absorption and diffusion as a function of wavelength) and in the physical characteristics (heat conductivity, vascularization, distribution of the nervous and muscle system), and this accordingly constrains the type of operation to be performed (cutting, suture, reduction of gum masses, removal of carious tissue, modeling of the tooth to apply implants or prostheses, et cetera).

In the case of soft tissues, the first studies were conducted by using a CO₂ laser operating at 10.6 μm in continuous mode. This laser was used to reduce mucous membranes and tissues of the gum and in procedures for treating periodontitis, i.e., the separation of the gum from the tooth, with the consequent formation of pockets that need to be eliminated. While this type of application has proved to be valid thanks to the swiftness of the procedure, to its effectiveness in the suture of vascularized tissues and to its uniformity in treating large surfaces, it has a risk of degradation of the tissues caused by the heating induced by the continuous laser.

U.S. Pat. No. 5,020,995 used, for example, a CO₂ laser in which the radiation has a wavelength of 10.6 μm. This instrument was applied to procedures affecting both soft tissues and hard tissues of teeth. Its main drawback is due on the one hand to the increase in the local temperature of the tissue in case of irradiation with high-energy, short-duration pulses and on the other hand to the heat propagation that occurs if the energy is reduced and the application time is increased.

Another drawback is also due to the fact that the radiation emitted by a CO₂ laser is absorbed by water to a large extent, with the result that its power to produce an incision in enamel and dentin is therefore limited. To obviate these drawbacks, it is necessary to resort to several technical refinements that relate to the energy level used and to the duration and frequency of the irradiation, and this demonstrates that this method depends on operating conditions that are clearly defined and therefore extremely limited.

Hard tissues require actions mostly of the ablative type, both to eliminate carious tissues and to remodel the shape of the tooth with the prospect of applying prostheses. The study and understanding of the thermal and optical properties of the components of the tooth, enamel and dentin, has reached a less advanced stage than that of soft tissue. Some aspects of the propagation of light and heat inside the tooth are in fact very complex. This is linked to the structural anisotropy of the tooth, which is formed to a large extent by radially orientated hydroxyapatite crystals.

The presence of nerve endings, blood vessels and fibroblasts and odontoblasts in the pulp chamber makes the tooth sensitive to the overheating produced during the procedure. Accordingly, irradiation with high-power pulses, required in order to induce tissue ablation, must be limited in time, so as to allow the action of cooling systems that keep the pulp chamber at a tolerable temperature.

Several kinds of laser have been used for this type of procedure. CO₂, excimer and neodymium in YAG (Nd;YAG) lasers were used initially. Considerable progress was achieved later by introducing lasers of the erbium in YAG or YSGG type (Er:YAG operating at 2.94 μm and Er:YSGG operating at 2.79 μm).

U.S. Pat. No. 5,554,029 and U.S. Pat. No. 5,456,603 use Nd:YAG and Er:YAG lasers to eliminate dental caries. The use of these instruments is combined with the use of dyes to be applied to the carious part of the tooth in order to increase its surface absorption, optimize its energy and thus allow to treat selectively the part to be removed.

These systems have the limitation of being very complicated in operation; moreover, since they are based on the principle of optical pumping of the active medium, their size is considerable and their efficiency is poor.

U.S. Pat. No. 6,325,791 uses a diode laser in the controlled process of polymerization of polymeric composite materials used in dental surgery. This system also uses a dye that is applied to the polymerizing material in order to match the wavelength of the laser light to the maximum absorption of said substance and achieve its polymerization starting from its innermost layers.

The advantage of this system is the simplified structure and easier handling of the diode laser with respect to a CO₂ laser or to a laser of the Nd:YAG or Er:YAG type considered above.

However, the range of wavelengths available with this source is limited, and this prevents use of this system in procedures on tooth tissue, since the local maximum of the absorption of this tissue, which is around 3 μm, cannot be used. The instrument is therefore limited to polymerization of the applied composite materials and is not applied in the ablation of hard surfaces of teeth.

Finally, it should also be noted that problems similar to the ones noted above for the dental sector can also occur in other fields of surgery, when it is necessary to act in order to treat other hard tissues, such as for example bones.

### DISCLOSURE OF THE INVENTION

The aim of the present invention is to provide a method that uses the radiation of a semiconductor or diode laser to treat hard tissues, such as for example the surfaces of teeth or bones, in which absorption of the laser radiation by the tissue is sufficient and limited to the surface of the tissue to be treated, so as to not allow said radiation to penetrate to the interior, consequently causing pain and/or degradation of sensitive biological tissues.

Within this aim, an object of the invention is to provide an apparatus for providing the method described above that is easy to handle and compact but at the same time reliable and highly efficient.

Another object of the invention is to limit the high costs entailed by the technologies of the prior art.

This aim and these and other objects that will become better apparent hereinafter are achieved by the method according to claim 1 and by the apparatus according to claim 8.

### BRIEF DESCRIPTION OF THE DRAWINGS

Further characteristics and advantages of the present invention will become better apparent hereinafter from the following detailed description thereof, taken with the accompanying drawing, wherein the only FIGURE is a lock diagram of the apparatus of the invention.

### WAYS OF CARRYING OUT THE INVENTION

The advantages provided by the use of a semiconductor or diode laser are several. First of all, as regards its dimensions, as a whole the diode laser can occupy a volume that is approximately 10 times smaller and can be approximately 5 times lighter than a laser having a conventional architecture (erbium in YAG).

These characteristics of compactness and low weight make it easy to carry, and therefore a single device can be used in all sanitary or home environments in which the physician can work. This advantage is combined with a higher electrooptical efficiency (equal to approximately 30%), which reduces significantly the consumption of electric power and the need for cooling.

Moreover, suppliers guarantee laser diodes for approximately 10 billion pulses, equivalent to an operating life of the device of approximately 8 years. Crystal lasers instead require maintenance over a period ranging from 1 to 3 years to replace the lamp and the crystal, for realignment, et cetera.

The research that has been conducted shows that by combining the use of a diode laser of adequate power with a chromophore that has a high absorption coefficient at the wavelength of the emitted laser radiation, it becomes possible to cut hard tissues even by operating with a laser at wavelengths for which the tissue has limited absorption. To make this process effective, the radiation must exceed a given fluence threshold on the surface of the tissue to be treated. This has provided the condition required to allow use of a semiconductor laser for this purpose. Moreover, this allows an enormous simplification in operation with respect to conventional solid-state lasers, such as lasers used in the prior art. The architecture of a semiconductor laser is in fact very simple and is composed of a small number of elements: a high-current pulse source, a low-voltage power source, a focusing system and an adapted cooling system. A conventional laser instead consists of medium-voltage power sections, high-voltage lamp ignition sections, and an optical resonator, an active medium and the corresponding cooling systems.

Another advantage of diode lasers, moreover, is their operating efficiency. The typical efficiency of a semiconductor laser is in fact higher than that of optical-pumping lasers by a factor that varies from 5 to 10. Moreover, although the current cost of semiconductor power lasers is high, a semiconductor laser system, for example for dental use, of the type according to the invention is already cheaper than the conventional alternative. The enormous prospect of growth of the semiconductor diode market ends to indicate that this convenience can only increase over time.

Another advantage of the system, moreover, is constituted by the extremely limited dimensions of laser diode sources, which allow to accommodate the source within a handpiece held in the surgeon's hand.

The continuing evolution in the field of semiconductor lasers and in their miniaturization in fact allows to consider technical solutions in which a laser light conveyance system, using optical guiding means such as for example optical fibers, is not required, the laser light beam being instead generated on the spot inside the handpiece that contains said laser. In this case, focusing on the area of the tissue to be treated is also direct, without beam guiding means.

The method for treating hard tissues according to the invention comprises the following steps, which are explained in detail hereinafter:

generating a radiation from a semiconductor laser source;

applying a chromophorous agent with high absorption at the wavelength of the laser to the region of the tissue to be treated, so as to have predominant absorption at the surface;

focusing the radiation on the surface of the tissue by means of an adapted optical system, such as to exceed the fluence threshold;

exceeding a fluence threshold of the laser radiation as a function of the tissue to be treated.

The apparatus that allows to provide this method therefore comprises:

a system for applying a chromophorous agent to the surface of the tissue;

a laser light source that contains at least one semiconductor laser;

an optical system for focusing the laser beam on the surface to be treated.

As shown in the FIGURE, which is provided in order to exemplify a possible way of carrying out the invention, by using a dye delivery system 3, such as for example an aerosol of the dye in the liquid phase, the chromophorous agent is applied to the surface of the tooth continuously. The system allows to control the delivery of the dye by means of an electronic controller 1 (PLC), which is connected to a power supply 2 (diode driver), which regulates the pulses of the emitted radiation. The quantity and concentration of the substance vary according to the type of tissue to be treated, to the operation to be performed, and to the necessary cooling action aimed at preventing degeneration of sensitive tissues.

The dyes that are applied in the present invention can in fact be chosen among different chromophorous agents, such as for example tricarbocyanines such as indocyanine green, black pigments such as India ink, Sudan Black or graphite and the many variations of methyl dye, from deep blue to violet and of course all equivalent compounds.

The key feature of the chromophorous agent consists in that it must have a high coefficient of absorption at the wavelength emitted by the laser diodes, so as to allow its absorption during application. Once the chromophore and its concentration have been selected according to this criterion, its application simultaneously with laser irradiation, capable of providing an energy density that is higher than the ablation threshold, allows to act effectively on hard tissues. The method accordingly allows to act like a scalpel and continuously.

The laser radiation used is generated by a system that comprises at least one semiconductor laser 4, and said system must have an overall power level of more than 100 W in pulsed operating mode. The duration of the pulses can vary between 10 and 50,000 μs.

The repetition rate, if the cutting of the surface to be treated must be continuous, is higher than 10 Hz. As an alternative, the system can operate by single burst or with a low repetition rate.

The wavelength of the emitted radiation can vary in a range comprised between 600 and 1000 nm, more preferably between 800 and 980 nm.

At this point, the radiation can be sent to an optical fiber 6 by means of a fiber coupler 5. This allows to convey the laser radiation to the handpiece held by the surgeon. The diameter of the optical fiber 6 vanes between 5 and 2000 μm. The optical beam is concentrated more effectively for an optical fiber diameter comprised between 400 and 600 μm.

In order to focus the laser radiation, at the end of the optical fiber 6 an adapted optical system, such as for example lenses or mirrors 7, is provided.

These allow to focus the beam on the tissue, obtaining a reduced impact surface that is able to exceed the ablation threshold. For example, the laser spot can vary between 300 and 500 μm.

The energy of a laser pulse in focused conditions is defined by the relation
E_{L}=P_{L}·t_{L}
where P_{L} is the power of the laser and t_{L} is the duration of the pulse. The resulting energy density, also termed fluence, is
F_{L}=E_{L}/S
where S is the surface struck by the pulse in focused conditions. The fluence threshold that needs to be exceeded in order to cut into a hard tissue is of course higher than the threshold to be used in the case of a soft tissue.

This, combined with the application of the dye, allows to act with the same instrument and during the same treatment on tissues that have different constitution and composition, be they healthy or altered, without incurring in the drawback of increase in internal temperature and consequent alteration of the nearby tissues. The best results can be achieved by varying the fluence in a range comprised between 20 and 100 J/cm².

The described apparatus according to the invention, moreover, can also comprise a system for cooling the surface to be treated. If the chromophore is applied in liquid form, said cooling occurs by means of the application of the chromophore.

Some examples related to the application of the instrument are described hereafter; they must not be understood as a limitation of the technical characteristics of the invention and therefore must be considered as intended merely for exemplification.

A 1% indocyanine green solution was applied to the surface of a healthy tooth by means of an aerosol. By using a system composed of two diode lasers with a power level P=140 W and with a wavelength equal to 808 nm, the radiation was conveyed within an optical fiber with a diameter of 600 μm. The radiation in output from the fiber was focused by means of two microlenses on a diameter of approximately 0.4 mm.

The surface of the tooth was struck with 1-ms pulses at the frequency of 20 Hz and at 85% of maximum power, which corresponded to a fluence of 80 J/cm². With this system it was possible to cut into the tissues of dentin and of tooth enamel.

It is evident to the person skilled in the art that the apparatus and method described according to the invention can be applied in several fields of medicine, and in particular that with the appropriate technical refinements entailed by the tissue to be treated, which arise from the knowledge and practice in the field, the described apparatus and method can be used not only in dentistry, as described extensively, but also more generally in the surgery of hard tissues (such as for example bones) when it is necessary to treat these tissues precisely and without damaging other more sensitive tissues and without causing pain.

The disclosures in Italian Patent Application No. MI2002A002332 from which this application claims priority are incorporated herein by reference.

1. A method for treating hard tissues, comprising the steps of:
generating a radiation from a semiconductor laser source;
applying a chromophorous agent with high absorption at the wavelength of the laser to a region of a tissue to be treated, so as to have predominant absorption at a surface of the tissue;
focusing the radiation on the surface of the tissue by means of an adapted optical system;
exceeding a fluence threshold of the laser radiation as a function of the tissue to be treated.

2. The method according to claim 1, characterized in that the fluence threshold of the laser radiation is between 20 and 100 J/cm².

3. The method according to claim 1, characterized in that the duration of the pulse is comprised between 10 and 50,000 μs.

4. The method according to claim 1, characterized in that the laser radiation is conveyed by means of a guided optical system.

5. The method according to claim 4, characterized in that the guided optical system is an optical fiber.

6. The method according to claim 1, characterized in that the focusing of the radiation in output from the optical fiber on the surface of the tissue is achieved by means of a system of lenses or mirrors.

7. The method according to claim 1, characterized in that the chromophorous agent is sprayed onto the tissue by means of an aerosol.

8. An apparatus for treating hard tissues, comprising:
a system for applying a chromophorous agent to a surface of a tissue;
a source of laser light that contains at least one semiconductor laser;
an optical system for focusing the laser light on the surface to be treated; characterized in that the fluence threshold of the generated laser radiation is variable.

9. The apparatus according to claim 8, characterized in that the fluence threshold of the laser radiation is comprised between 20 and 100 J/cm².

10. The apparatus according to claim 8, characterized in that the duration of the pulse is comprised between 10 and 50,000 μs.

11. The apparatus according to claim 8, characterized in that the laser radiation is conveyed by means of a guided optical system.

12. The apparatus according to claim 11, characterized in that the guided optical system is an optical fiber.

13. The apparatus according to claim 12, characterized in that the optical fiber has a diameter of 5 to 2000 μm.
